(19) United States
(12) Patent Application Publication
(10) Pub. No.: US 2011/0144966 A1
(43) Pub. Date: Jun. 16, 2011

(54) METHODS FOR PREDICTION OF BINDING POSES OF A MOLECULE

(76) Inventors: William A. Goddard, III, Pasadena, CA (US); Ravinder Abrol, Pasadena, CA (US); Ismet C. Tanrikulu, Madison, WI (US); Adam R. Griffith, Oak Ridge, TN (US)

(21) Appl. No.: 12/944,700

(22) Filed: Nov. 11, 2010

Related U.S. Application Data
(60) Provisional application No. 61/260,295, filed on Nov. 11, 2009.

(51) Int. Cl. G06G 7/58

(52) U.S. Cl. 703/11

(57) ABSTRACT

A method for prediction of binding poses of a binding molecule to a target molecule is provided. The method involves a step of providing, clustering, and evaluating binding poses of the binding molecule. The providing and clustering of the poses is performed by a single or multiple iteration procedure. The evaluation of the poses is determined from interaction energies between particular poses and the target molecule.

### CROSS REFERENCE TO RELATED APPLICATIONS

The present application claims priority to U.S. Provisional Application No. 61/260,295, entitled “DarwinDock/GenDock: A New Method to Identify Ligand Binding Sites in Proteins”, filed on Nov. 11, 2009, which is incorporated herein by reference in its entirety. The present application can be related to U.S. application Ser. No. 12/142,707, entitled “Methods for Predicting Three-Dimensional Structures for Alpha Helical Membrane Proteins and their use in Design of Selective Ligands”, filed on Jun. 19, 2008, docket number P217-US, by Ravinder Abrol, William A. Goddard III, Adam R. Griffith, and Victor Wai Tak Kam, which is incorporated herein by reference in its entirety. The present application can be related to U.S. application Ser. No. ______, docket number P638-US, entitled “Methods for Prediction of Binding Site Structure in Proteins and/or Identification of Ligand Poses”, filed on Nov. 11, 2010, by William A. Goddard III, Adam R. Griffith, Ravinder Abrol, and Ismet Caglar Tanrikulu, which is incorporated herein by reference in its entirety.

### FIELD

The present disclosure relates to binding poses. In particular, it relates to methods for prediction of binding poses of a molecule.

### BACKGROUND

When any two molecules interact, each molecule induces a change in pose of the other. For instance, when a ligand binds to a protein, a conformational change is induced in both the ligand and the protein. Docking is a method for predicting poses of one molecule when it binds to another molecule to form a stable configuration. Evaluation of potential poses (also known as conformations) of a particular molecule can depend on interaction energy between the two molecules for each potential pose of the particular molecule. The evaluation of the potential poses is generally a difficult task, especially in terms of computational power and time. The docking process can be used, for instance, in rational drug design, where design of one molecule (generally the drug) is based on knowledge of the molecule's binding pose in the target molecule or molecules (usually a protein or system of proteins and associated molecules).

### SUMMARY

According to a first aspect of the disclosure, a method for predicting binding poses of a binding molecule is provided, wherein the binding molecule is adapted to be bound to a target molecule, the method comprising: providing at least one molecular pose for the binding molecule; clustering the at least one molecular pose into at least one family, wherein the clustering is based on position of each molecular conformation in the target molecule; selecting a family head for each family in the at least one family based on geometric properties; selecting a full set or subset of families based on interaction energy between each family head and the target molecule; and selecting a full set or subset of molecular poses from among the molecular poses in the full set or subset of families based on interaction energy between each molecular pose and the target molecule. A computer readable medium comprising computer executable software code stored in the computer readable medium can be executed to carry out the method provided in the first aspect of the disclosure.

According to a second aspect of the disclosure, a method for predicting ligand poses is provided, wherein a ligand is adapted to be bonded with a receiving protein, comprising: removing one or more residues on the receiving protein to form a mutant protein; providing at least one ligand pose based on an input ligand pose and the mutant protein; clustering the at least one ligand pose into at least one family, wherein the clustering is based on position of each ligand pose in the mutant protein; selecting a family head for each family in the at least one family based on geometric properties; selecting a full set or subset of families based on interaction energy between each family head and the mutant protein; and selecting a full set or subset of ligand poses from among the ligand poses in the full set or subset of families based on interaction energy between each ligand pose and the mutant protein. A computer readable medium comprising computer executable software code stored in the computer readable medium can be executed to carry out the method provided in the second aspect of the disclosure.

The methods and systems herein described can be used in connection with any applications wherein prediction of a binding poses of a molecule is desired.

The methods and systems herein disclosed can therefore have a wide range of applications in fields such as fundamental biological research, microbiology and biochemistry, but also to farm industry and pharmacology. In particular, the methods and systems herein disclosed can be used to design a drug able to bind to a binding site on a target molecule (such as a protein) associated with desired biological activities in connection with treatment of a certain condition.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows an embodiment of a binding pose prediction method for use in selecting binding poses of one molecule to a target molecule.

FIG. 2 shows an example of number of families generated through different iterations of the method shown in FIG. 1.

FIG. 3 shows another embodiment of the binding pose prediction method.

### DETAILED DESCRIPTION

The present disclosure presents a broadly applicable method, known as DarwinDock, for predicting binding poses of a binding molecule to a target molecule that is executed as a computer program aimed at simulating and analyzing interactions between the binding molecule and the target molecule.

As used in this disclosure, the term “binding molecule” indicates any molecule capable of interaction with a binding site of another molecule. Binding molecules in the sense of the present disclosure (herein also generally called ligands) include, for example, proteins, peptides, and small molecules.

The term “protein” as used herein indicates a polypeptide with a particular secondary and tertiary structure that can participate in, but not limited to, interactions with other biomolecules including other proteins, DNA, RNA, lipids, metabolites, hormones, chemokines, and small molecules.

The term “polypeptide” as used herein indicates an organic polymer composed of two or more amino acid monomers and/or analogs thereof. The term “polypeptide” includes amino acid polymers of any length including full length proteins and peptides, as well as analogs and fragments thereof. A polypeptide of three or more amino acids is typically also called a peptide. As used herein the term “amino acid”, “amino acidic monomer”, or “amino acid residue” refers to any of the twenty naturally occurring amino acids including synthetic amino acids with unnatural side chains and including both D and L optical isomers. The term “amino acid analog” refers to an amino acid in which one or more individual atoms have been replaced, either with a different atom, isotope, or with a different functional group but is otherwise identical to its natural amino acid analog.

The term “small molecule” as used herein indicates an organic compound that is of synthetic or biological origin and that, although might include monomers and/or primary metabolites, is not a polymer. In particular, small molecules can comprise molecules that are not protein or nucleic acids, which play a biological role that is endogenous (e.g. inhibition or activation of a target) or exogenous (e.g. cell signaling), which are used as a tool in molecular biology, or which are suitable as drugs in medicine. Small molecules can also have no relationship to natural biological molecules. Typically, small molecules have a molar mass lower than 1 kg·mol⁻¹. Exemplary small molecules include secondary metabolites (such as actinomicyn-D), certain antiviral drugs (such as amantadine and rimantadine), teratogens and carcinogens (such as phorbol 12-myristate 13-acetate), natural products (such as penicillin, morphine and paclitaxel) and additional molecules identifiable by a skilled person upon reading of the present disclosure.

In several embodiments the binding molecule is a peptide or a small molecule.

The term “target molecule” in the sense of the present disclosure include any molecule having a binding site and can also include proteins lipids and additional molecule identifiable by a skilled person. In several embodiments, the target molecule is a protein.

In an embodiment, wherein the binding molecule and/or the target molecule include sidechain derivative of the binding and/or target molecules wherein certain sidechains are replaced with a different sidechain, can be used. In embodiments wherein the binding and target molecules are proteins sidechain can be typically replaced with alanine or other, generally small residues (process generally called alanization).

In particular, the term “alanization” refers to a sidechain modification procedure that allows the user to replace a set of residues (typically large, non-polar residues) with alanines (or other, generally small, residues). The purpose of alanization is generally to allow focus on the non-alanized residues, which are generally polar residues since polar residues are the residues that typically anchor the ligand to the protein. However, the residues being replaced need not be large, non-polar residues. For instance, from prior experimental data, it may be determined that tryptophan (a large, non-polar residue) is critical to protein-ligand binding and thus should not be alanized. In certain cases, residues on which alanization is performed can be modified by the user. SCREAM and SCRWL are examples of programs that may perform this sidechain modification procedure, although other sidechain optimization programs may also be used. Adjustable parameters may include, but is not limited to, which residue types to alanize, specific residues to alanize, specific residues to not alanize, and what residue type or types to change to. As previously mentioned, the replaced residues are generally replaced with alanine; however, other residues may also be used.

The term “dealanization” is the opposite procedure relative to alanization. In particular, dealanization “restores” or replaces the alanized sidechain with the original sidechain residues. Dealanization may also involve restoring the original sidechain at its original coordinates (prior to the alanization).

In the following description reference will be often made to exemplary embodiments where the binding molecules are peptides or small molecules and the target molecule are proteins. A skilled person will be able to adapt the teaching provided with reference to peptides and small molecules to other binding molecules and the teaching provided for target proteins to other target molecules in the sense of the present disclosure.

In one embodiment of the computer program, the DarwinDock method of the present disclosure can be employed in predicting binding poses of small molecules ligands when the small molecules are interacting with target proteins. In an embodiment, the DarwinDock method can be used in rational drug design.

Throughout this disclosure, a “pose” (such as a ligand pose or a target protein pose) indicates rotational and translational orientations of a molecule relative to another molecule. It takes into account molecular flexibility, which refers to physical flexibility of any particular molecule. Although many poses are possible, some poses are more desirable than others. As will be described later in the disclosure, desirability of a given pose is based on force-field based energy scoring between the binding molecule and the target molecule. Force-field based energy scoring is based on intermolecular energies (such as van der Waals forces) between atoms of the binding and target molecules and/or intramolecular energies (also known as strain energies) within each of the binding and target molecules itself. Intramolecular energies result from both molecules (the binding molecule and the target molecule onto which the binding molecule binds) changing poses and thus rearranging themselves to better bind with each other.

It is generally the case that a structure of the molecular system comprising the binding molecule and the target molecule is desired. Evaluation of the structure is based on the energy scoring. For a ligand-protein system, for instance, a desired structure can be obtained by modifying the ligand-protein system itself by repositioning or replacing certain residues in a receiving protein. Exemplary ways of performing the modification include, but are not limited to, modifying a binding site in the target protein and modifying specific residues in the target protein. The modifications affect predictions of the ligand-protein system and portions of the ligand-protein system through direct changes in the ligand and/or the target protein.

Alternatively or in combination, the structure can also be obtained through adjusting precision of energy calculations associated with the structure of the ligand-protein system. This adjustment allows for more accurate energy scoring, which affects predictions of the ligand-protein system and portions of the ligand-protein system (for instance, the ligand poses and the structure of the receiving protein). Exemplary ways of performing the adjustments include, but are not limited to, charge modification through neutralization or reapplication of charges, energy minimization, and explicit water placement.

The DarwinDock method for predicting binding poses implements a method that includes handling molecular flexibility completeness searching strategy for binding sites of the binding molecule determined based on different poses of the binding molecule, and force-field based energy scoring for sorting the different poses. The method is flexible enough to enable a slow but accurate prediction of molecular binding poses as well as a fast prediction, and also any speed and accuracy criteria in between. For instance, the DarwinDock method has been designed in a way that allows a user to define a program mode using only a few input parameters, which allows for an incremental transition between fast and slow modes. Input parameters of DarwinDock are listed in Appendix 1, which forms an integral part of the present disclosure.

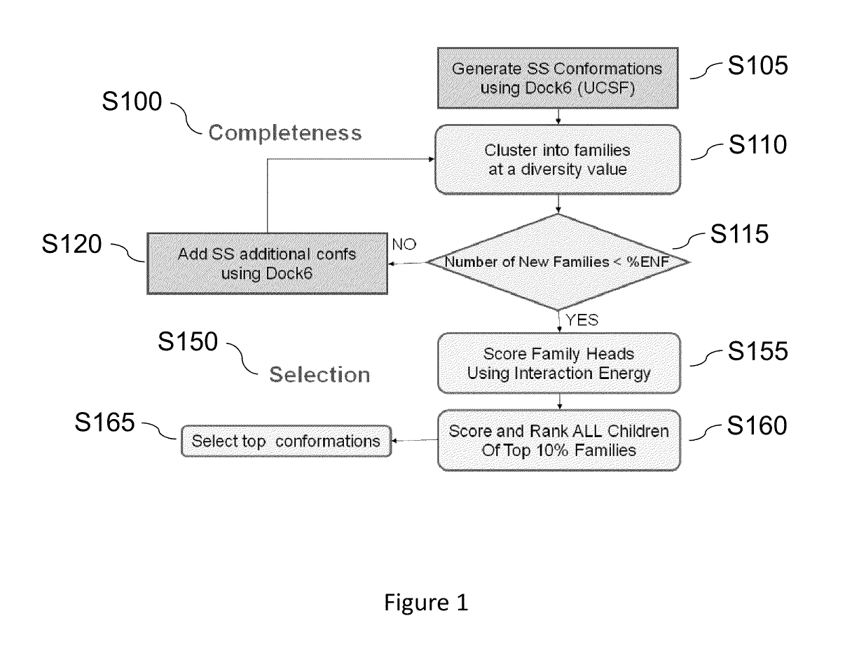

FIG. 1 shows an embodiment of a binding pose prediction method comprising a “Completeness” step (S100) and a “Selection” step (S150). Diverse molecular poses (differing in internal torsional degrees of freedom) can be generated outside of DarwinDock using another program such as MacroModel [Schrodinger Inc.] and serve as input to DarwinDock. In this case, DarwinDock can be called for each of the molecular poses. Candidate poses generated by the docking scheme for each of the molecular poses can be combined at the end of the DarwinDock method and ranked based on a force-field based scoring energy.

The DarwinDock method of FIG. 1 takes as an input molecular poses. In a first step called “Completeness” (S100), DarwinDock uses the input molecule pose (S105), generally generated by another program, and a target molecule to generate a population of molecular binding poses large enough to cover the search space at a desired convergence level. The search space consists of all possible orientations of both the binding molecule and the target molecule when the two molecules bind with one another. These poses can be generated (S105) using another program, such as UCSF Dock6. For instance, Dock6 uses the search space defined by a set of sphere centers to place the input molecular poses by matching three non-collinear atoms with three sphere centers. In a second step called “Selection” (S150), a search for low-energy molecular binding poses is carried out over the population of molecular binding poses generated in the “Completeness” step (S100). Each of these steps (S100, S150) will now be described in detail.

As previously mentioned, when the binding molecule binds to the target molecule, a conformational change is induced in both molecules. The induced conformational change in the binding molecule can be accounted for by docking multiple diverse poses of the binding molecule that span the complete space of the binding molecule's internal torsional degrees of freedom. Thus, different poses of the binding molecule are docked to the same target molecule in order to obtain a desirable (based on energy scoring) binding between the two molecules.

With reference back to FIG. 1, in order to obtain a set of molecular poses that thoroughly sample the search space, the binding conformation prediction method utilizes multiple rounds of pose-generation (S105) and clustering (S110). The search space is defined through a set of spheres generated over the target molecule using a particular input pose of the binding molecule. This set of spheres defines empty space in or around the target molecule onto which the binding molecule can bind.

The entire target molecule is scanned in order to find regions most likely to bind with the binding molecule, namely the putative binding region. This scanning can be performed using a docking method involving one molecular pose and applying a method such as that used by Dock6 to generate molecular poses. The scan yields one or two regions, each with a volume, generally, of 1000 to 2000 Å³ (a cube with sides of 10 Å to 14 Å), over which to predict optimal molecular poses.

In an initial round of the “Completeness” step (S100), a user-defined number of molecular poses, referred to as the step-size (SS), is generated using the sphere regions defined over the target molecule. A second step (S110) involves using a clustering algorithm, such as that described in Appendix 2, which forms an integral part of the present disclosure. Families are formed based on position of molecular poses in the target molecule. The clustering algorithm distributes the starting set of molecular poses into families, where a family is a group of molecular poses in the population of molecular poses that show similar positions (also known as orientations) with respect to the target molecule.

In a second round of the “Completeness” step (S100), an additional SS molecular poses is generated (S120) to reach 2×SS number of molecular poses, and the clustering (S110) of the molecular poses into families is repeated. The population of molecular poses in the second round contains all SS poses generated in the first round as well as SS new poses. During the clustering (S110) in the second round, if a new pose is found to be similar in its placement in the target molecule to a pose carried over from the first round, the new pose is grouped together with the previously existing pose in the same family. However, if a new pose is distinct from all previously existing poses in the population of molecular poses, the new pose is placed into a new family.

As described in Appendix 2, the clustering (S110) into families is based on RMSD (root mean square difference) calculations between any two molecular poses. Specifically, distance between two molecular poses is calculated by averaging deviation of the two poses over all heavy (non-hydrogen) atoms. Hydrogen atoms are generally not taken into account because their location depends on location of other atoms and they contribute little to an RMSD calculation.

It should be noted that order in which particular molecular poses are generated (or used) in each round is random. For instance, 20×SS molecular poses can be generated throughout the search space, and SS molecular poses are utilized in each round of the “Completeness” step (S100). It should also be noted that there need not be a constant step-size. In other words, the number of molecular poses generated (or used) in each round need not be equal.

If the search space is small, the initial SS poses can be sufficient to sample the entire space. In such a case, further introduction of new poses will not result in formation of new families since there will be a pre-existing pose close (in relative position within the target molecule) to any new pose introduced. Specifically, the poses introduced in the second round will be combined with those from the first round and re-clustered into families with pre-existing poses, and thus the second round results in no exclusively-new families. As used in this disclosure, exclusively-new families refer to families that have no poses from a previous round.

In general, however, the search space will be large and will require a substantial number of poses for complete sampling. Therefore, after addition of an extra SS poses to the population, exclusively-new families, which only contain poses from the most recent number of poses, will emerge. If the original population size of molecular poses was too small with respect to the size of the search space, the number of exclusively-new families introduced will generally be high.

From another standpoint, if only a few exclusively-new families are introduced in a particular round, pre-existing poses (poses generated prior to this particular round) is likely to have been successful in representing most of the available search space. Thus, the number of exclusively-new families introduced with the addition of SS poses can be used as a metric to monitor how well the current population of poses represents the search space.

However, the number of families that can successfully represent a given search space will depend on the size and shape of the search space and varies greatly with each binding molecule and target molecule pair. Therefore, an absolute number of exclusively-new families will be indicative of different levels of coverage in different systems. Using a ratio of exclusively-new family count to total number of families provides a metric of completeness that is system-independent.

Starting with the second round of the “Completeness” step (S100), the DarwinDock method monitors percentage of exclusively-new families introduced over all families (S115), which is referred to as % ENF in FIG. 1. In each successive round, an additional SS poses are introduced into the population (S120), resulting population is clustered (S110), and % ENF is calculated (S115). When the % ENF drops below a user-defined threshold of completeness, molecular pose generation is halted, and the search space coverage is declared complete. Although it is possible to continue this process until no exclusively-new families are generated (% ENF=0%), % ENF of 2% or 5% are commonly used as the completeness threshold in DarwinDock runs due to computational and time constraints.

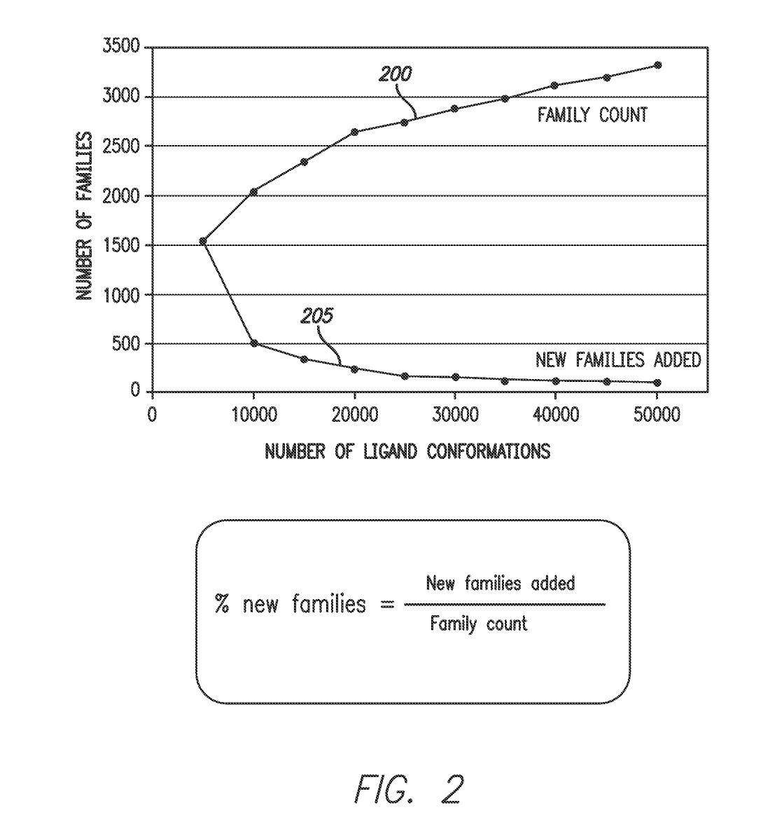

FIG. 2 shows an example of families generated in each iteration of the “Completeness” step (S100 in FIG. 1), as performed in DarwinDock. In this case, the binding molecule is a ligand while the target molecule is a protein. In this example, the step-size (SS) is 5000, signifying that 5000 ligand poses are added in each iteration. A top curve (200) shows cumulative number of families for a given number of ligand poses while a bottom curve (205) shows number of exclusively-new families added in an iteration. For instance, in a first iteration (number of ligands is 5000), there are 1500 families. In a last iteration shown in FIG. 2 (number of ligands is 50000), there are about 3300 families and about 50 exclusively-new families generated by the last iteration. In this example, % ENF is about 50/3300=1.5% for the last iteration.

With reference back to FIG. 1, the “Selection” step (S150) is also depicted. The “Selection” step (S150) begins once it has been determined (in step S115) that the % ENF for an iteration is below the user-defined threshold of completeness. The search for the binding poses that best represent the search space within a comprehensive set of poses obtained from the “Completeness” step (S115) is implemented in two steps: 1) identification of the best families and 2) identification of best poses within the top families. It should be noted that “best” is dependent on specified criteria. In the embodiment of the “Selection” step (S150) shown in FIG. 1, interaction energies between a molecular pose and the target molecule are used as a metric for determining the best binding poses.

The “Selection” step (S150) for the binding poses uses interaction energy between a particular molecular pose and the target molecule as a metric for identifying the best families and poses within the best families. For each of the families, a family head is selected. The family head is one member of each family that best geometrically represents the members of the family. Specifically, the family head, also referred to as a centroid pose, is one of the poses closest in RMSD (and thus geometrically closest) to all the other poses in the family.

In a first step (S155) of the “Selection” step (S150), the best families are determined by ranking them according to an energy score based on interaction energy determined for each of the family heads. Specifically, the families are ranked based on the interaction energy between the family head and the target molecule. Top families are identified as the families with the best scoring family heads, where best scoring refers to lowest energy. In many cases, top 10% of the families are retained for a second step (S160) of the “Selection” step (S150).

A variety of scoring energies can be used in selecting top poses. Each of the scoring energies depends on interaction energy between the binding molecule and the target molecule. Scoring energies can be a function of total interaction energy, which is a sum of vacuum energy of the binding molecule and nonbond energy between the binding molecule and the target molecule; polar interaction energy, which is the polar component of the total interaction energy; and phobic interaction energy, which is the hydrophobic component of the total interaction energy. Nonbond energy refers to the sum of Coulomb, van der Waals, and hydrogen-bond energies.

In the second step (S160) of the “Selection” step (S120), all members of the selected top families are scored and ranked. Top poses, which are those molecular poses that best interact (have lowest interaction energy) with the target molecule among the top families, are then selected (S165) and reported as outputs of the DarwinDock method. Number of poses output by the DarwinDock method is user-defined.

Accuracy of the “Selection” step (S150) depends heavily on assignment of representative family heads and accuracy of the energy scoring. A poorly assigned family head can cause an otherwise successful set of molecular poses to be excluded from the set of top families, and thereby can reduce accuracy of a final set of molecular poses output by DarwinDock. This issue becomes significant when geometric size (the physical volume taken up by poses in a family) of families becomes large, making it difficult to determine a single family head that can be representative of the whole family.

Due to these factors, a clustering algorithm (see Appendix 2) can be used to provide tight families in a fast manner instead of focusing on achieving mathematically well-defined families. A tight family is one where all members are within a small threshold RMSD, also referred to as a diversity value. An exemplary range of diversity values is between 1.0 and 2.4 Å RMSD. An RMSD of 2.0 Å is generally a good compromise between speed and accuracy.

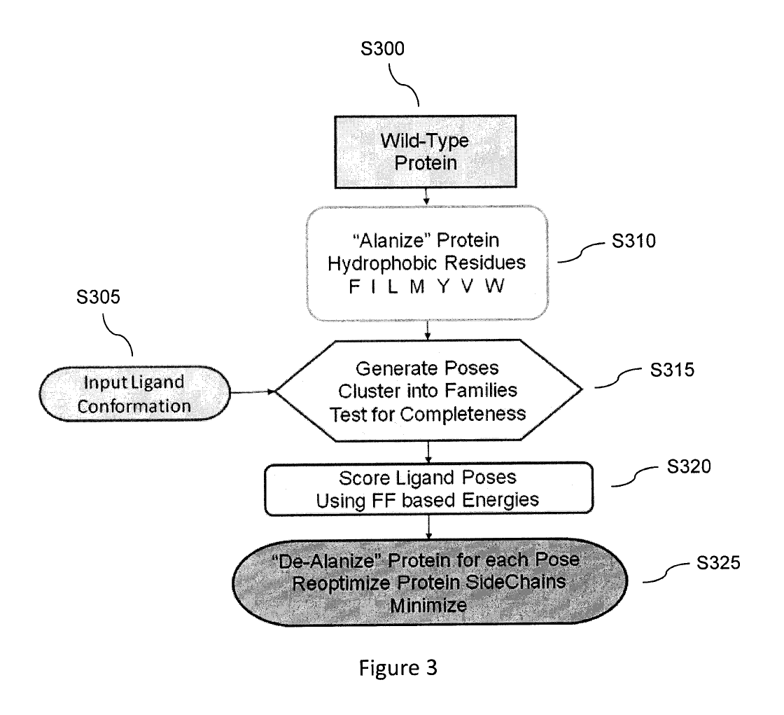

FIG. 3 shows another embodiment of the DarwinDock method utilized binding ligand poses to a receiving protein. The DarwinDock method takes as input a “wild-type” protein (S300), which is the dominant form of a protein found in the general population, and input ligand poses (S305). This embodiment of the DarwinDock method comprises removing (S310) certain residues of the receiving protein to obtain a mutant protein; generating, clustering, and selecting (S315) of ligand poses based on docking the poses to the mutant protein; and energy scoring each of the ligand poses (S320) based on docking the poses to the mutant protein. The “Completeness” step (S100 in FIG. 1) and the “Selection” step (S150 in FIG. 1) are used in steps S315 and S320 of FIG. 3, respectively. As previously mentioned, generation of ligand poses can be performed by other programs such as Dock6. Optionally, this embodiment of the DarwinDock method can further comprise reintroducing the residues (S325) previously removed in step S310 to obtain the original “wild-type” protein and selecting a final set of ligand poses based on the original “wild-type” protein.

As previously stated with reference to arbitrary molecules, when a ligand binds to a receiving protein, a conformational change is induced in both the ligand and the receiving protein. The induced conformational change in the ligand can be accounted for by generating and docking multiple diverse ligand conformations to the receiving protein. On the other hand, the conformational changes in the receiving protein can be induced in the receiving protein's backbone or sidechains, or both. For computational purposes, the conformational changes in receiving protein's backbone are generally minimal and thus assumed not to change upon ligand binding. On the other hand, potential conformational changes in the sidechains induced by ligand binding are generally too numerous to completely sample. By considering sidechain flexibility, effective search space for ligand binding to the receiving protein is increased.

With reference to FIG. 3, the sidechain flexibility can be implemented by removing (S310) certain residues of the receiving protein. The certain residues to be removed can be based, for instance, on polarity and/or size of the residue. Additionally, the certain residues can be selected based on prior experimental information. In some cases, for instance, a particular residue can be known to be critical in the binding of the ligand and the receiving protein, and thus the particular residue should not be removed regardless of other criteria such as polarity and/or size of the residue. The receiving protein with certain residues removed (or otherwise modified) is hereafter referred to as the mutant protein.

As shown in FIG. 3, one method of implementing sidechain flexibility is to alanize, using a procedure called alanization, certain sidechains of the protein considered not critical to ligand binding, while keeping the other sidechains fixed. Specifically, in the embodiment of DarwinDock shown in FIG. 3, an “Alanization” step (S310) is performed, where certain residues in the receiving protein are replaced with alanines (or other, generally small residues) to maximize search space for ligand binding. More in particular, since strong interactions between a receiving protein and a ligand are generally hydrophilic in nature (salt-bridge, hydrogen-bond, and so forth), hydrophobic residues in the receiving protein can be alanized. One possible selection of hydrophobic residues to be alanized can include phenylalanine (F), isoleucine (I), leucine (L), methionine (M), tyrosine (Y), valine (V), and tryptophan (W). The resulting protein is referred to as the mutant protein or more specifically an “alanized” protein.

The generating, clustering, and selecting (S315) involves docking each of the ligand poses to the mutant protein (and not the “wild-type” protein). The generating of ligand poses can be performed by another program such as Dock6. A general description of Dock6 can be found at the internet page of the http site dock.compbio.ucsf.edu/index.html at the filing date of the present disclosure. The clustering and selecting aspects of step S315 are performed using the “Completeness” step (S100 in FIG. 1), which has been previously described in this disclosure. The “Completeness” step (S100 in FIG. 1) is performed using a set of ligand poses and the mutant protein.

Subsequent to the generating, clustering, and selecting (S315), energy scoring (S320) is performed to evaluate binding of each ligand pose to the mutant protein. The energy scoring (S320) is performed using the “Selection” step (S150 in FIG. 1). The energy scoring (S320) ranks each of the ligand poses from most to least desirable (lowest to highest interaction energy, respectively). A user-defined number of poses will then be output from the energy scoring (S320) step.

Following the energy scoring (S320), the resulting set of ligand poses can be further analyzed and narrowed down. The residues previously replaced (S310) are reintroduced (S325). In other words, the original receiving protein (in this case, the “wild-type” protein) prior to removal of the residues is reconstructed from the mutant protein. If “Alanization” (S310) were performed to obtain an alanized protein, then “Dealanization” (S325) of the alanized protein is performed by reintroducing the originally alanized residues.

Although originally removed residues are generally not critical to binding between the ligand and the target protein, the originally removed residues can still have an effect (such as physical size or interaction energy) that can be considered in selecting a final set of ligand poses. After the reintroduction (S310) of the residues or, in one particular embodiment, the “Dealanization” step (S325), a further selection can be performed using the energy scoring (S320) or equivalently the “Selection” step (S150) shown in FIG. 1. Specifically, evaluation of interaction energies is based on ligand poses and the “wild-type” protein (as opposed to the mutant protein). This further selection generally re-ranks each of the ligand poses to take into account originally removed residues. For instance, after reintroduction of the removed residue, a previously desirable ligand pose (based on the mutant protein) may no longer be desirable (based on the “wild-type” protein).

Further optimization can then be performed on the set of ligand poses to further improve accuracy of ranking of the ligand poses and/or to better optimize the ligand-protein system by adjusting either, the ligand, the receiving protein, or both. This optimization is generally performed by other programs such as SCREAM, SCRWL, and GenDock.

One factor in identifying realistic coordinates for a binding molecule bound to a target molecule is having an accurate way to score the interaction energy between the molecular poses and the target molecule and assign each pose a measure of success. The measure of success is used for determining which poses are better or more accurate. For instance, in a ligand-protein system, success refers to being able to reproduce a ligand position observed in ligand-protein co-crystals. A co-crystal contains real world coordinates for components within the ligand-protein system.

An all-atom molecular mechanics force-field (such as DREIDING 3) is used to determine extent of interaction between the molecular pose and the target molecule. However, in order for a force-field like DREIDING to provide a realistic energy score on each pose, the atomistic model of the target molecule associated with the molecular pose should be accurate. Obtaining this accuracy, however, is generally challenging. The bound poses of the binding molecule and the target molecule are tightly linked, and when the binding molecule's conformation is unknown, it is generally difficult to generate an atomistically accurate model of the target molecule's conformation. For instance, it is difficult to obtain accurate coordinates for sidechains in a protein positioned to interact with a given ligand pose.

Errors in models used in scoring make it difficult to correctly identify interactions between a pose of the binding molecule and the target protein. Among these errors, errors due to polar interactions, such as Coulombic and hydrogen-bonding interactions, generally act as main determinants of specificity in molecular recognition. Because magnitude of polar interactions has strong dependences on relative orientation and distance between polar groups on the binding molecule and the target molecule, small errors in pose placement can be detrimental to the energy score of the two molecules. This is in contrast to van der Waals interactions, which roughly measure surface contact and are usually not significantly affected by errors in pose placement.

Further consideration is given for the case of a ligand-protein system. Considering importance of correct identification of polar interactions between the ligand and the receiving protein, alanization, the method previously employed to remove bulky, hydrophobic sidechains from the receiving protein, is used to allow better sampling of polar groups on the receiving protein by ligand poses. In some cases, exposing polar groups on the receiving protein through alanization and scoring ligand poses using only polar components of the interaction energy (known as polar energy) worked well for ligands rich in hydrogen-bond donors and acceptors.

However, the method of using alanization proves to be inconsistent when used on largely hydrophobic ligands. In this case, switching the scoring energy from polar to hydrophobic (known as phobic energy) drastically improves quality of the search results, despite the absence of hydrophobic sidechains on a model of the receiving protein. Consequently, a scoring scheme can be chosen based on nature of the ligand. This scheme generally involves user intervention in selecting which sidechains should and should not be replaced and which scoring energy to use.

A hybrid scoring method can be utilized that involve less or no user intervention. In this case, top poses are determined independently using three different energy schemes: polar, phobic and total energy scores. Total energy is the sum of all DREIDING energy components and includes polar and phobic components. Top 40 poses according to each scoring scheme are then pooled together and reported. This has been applied to a standardized benchmarking set called the DUD set, which contains co-crystal cases for 40 proteins. The results are shown in Table 1, which shows the number of hits within 0.6 Å, 1.0 Å, and 2.0 Å for all 40 cases. The hybrid scoring method performs well overall in producing near-native co-crystal poses, as shown in Table 1 below.

TABLE 1
DarwinDock performance for standard
DUD database of 40 co-crystals.

| DUD System | TotalConfs | RMSD | | |
|---|---|---|---|---|
| (Ala) | (Out of 120) | <0.6A | <1.0A | <2.0A |
| ace | 102 | 3 | 25 | 56 |
| ache | 116 | 1 | 3 | 9 |
| ada | 100 | 6 | 16 | 26 |
| alr2 | 111 | 0 | 0 | 8 |
| ampc | 104 | 0 | 1 | 2 |
| ar | 88 | 7 | 33 | 36 |
| cdk2 | 109 | 1 | 8 | 25 |
| comt | 116 | 0 | 1 | 1 |
| cox1 | 113 | 0 | 6 | 27 |
| cox2 | 100 | 2 | 11 | 38 |
| dhfr | 91 | 3 | 17 | 48 |
| egfr | 107 | 1 | 5 | 12 |
| er_agonist | 88 | 0 | 3 | 5 |
| er_antagonist | 102 | 9 | 25 | 43 |
| fgfr1 | 109 | 1 | 3 | 14 |
| fxa | 99 | 1 | 3 | 15 |
| gart | 114 | 0 | 0 | 0 |
| gpb | 61 | 19 | 41 | 50 |
| gr | 82 | 12 | 45 | 58 |
| hivpr | 101 | 0 | 1 | 2 |
| hivrt | 112 | 0 | 2 | 2 |
| hmga | 105 | 1 | 1 | 5 |
| hsp90 | 94 | 5 | 11 | 22 |
| inha | 84 | 14 | 38 | 45 |
| mr | 94 | 13 | 33 | 39 |
| na | 108 | 2 | 5 | 16 |
| p38 | 106 | 2 | 6 | 6 |
| parp | 107 | 1 | 4 | 6 |
| pde5 | 109 | 0 | 4 | 8 |
| pdgfrb | 74 | 8 | 22 | 37 |
| pnp | 86 | 11 | 26 | 60 |
| ppar | 82 | 6 | 20 | 32 |
| pr | 88 | 6 | 29 | 60 |
| rxr | 88 | 9 | 27 | 50 |
| sahh | 90 | 0 | 4 | 11 |
| src | 119 | 0 | 0 | 4 |
| thrombin | 102 | 0 | 4 | 12 |
| tk | 101 | 5 | 12 | 26 |
| trypsin | 80 | 11 | 22 | 47 |
| vegfr2 | 111 | 2 | 6 | 24 |

In an embodiment, steps in the DarwinDock method have been implemented as Python programs which call other underlying procedures or modules written in Perl, Python, or C. In principle, the DarwinDock method can be written in Perl, Python, Ruby, C, or Fortran. The executable steps according to the methods and algorithms of the disclosure can be stored on a medium, a computer, or on a computer readable medium. All the software programs were developed, tested and installed on desktop PCs and multi-node clusters with Intel processors running the Linux operating system. The various steps can be performed in multiple-processor mode or single-processor mode. All programs should also be able to run with minimal modification on most Linux-based PCs and clusters. Helper programs not directly called by DarwinDock, but which may be used in preparation or analysis of DarwinDock runs, can be found in Appendix 3, which forms an integral part of the present disclosure.

The examples set forth above are provided to give those of ordinary skill in the art a complete disclosure and description of how to make and use the embodiments of the methods for prediction of binding poses of a molecule of the disclosure, and are not intended to limit the scope of what the inventors regard as their disclosure. Modifications of the above-described modes for carrying out the disclosure can be used by persons of skill in the art, and are intended to be within the scope of the following claims.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The entire disclosure of each document cited (including patents, patent applications, journal articles, abstracts, laboratory manuals, books, or other disclosures) is hereby incorporated herein by reference.

A number of embodiments of the disclosure have been described. Nevertheless, it will be understood that various modifications can be made without departing from the spirit and scope of the present disclosure. Accordingly, other embodiments are within the scope of the following claims.

### LIST OF REFERENCES

[1] Bray J K and Goddard W A (2008). The structure of human serotonin 2c G-protein-coupled receptor bound to agonists and antagonists. J. Mol. Graph. Model. 27, 66-81.
[2] Cho A, et al. (2005). The MPSim-Dock Hierarchical Docking Algorithm: Application to the eight trypsin Inhibitor co-crystals. J. Comp. Chem., 26, 48-71.
[3] Fanelli F and De Benedetti P G (2005). Computational Modeling Approaches to Structure-Function Analysis of G-Protein-Coupled Receptors. Chem. Rev. 105, 3297-3351.
[4] Floriano, W. B., Vaidehi, N., Singer, M., Shepherd, G., Goddard III, W. A. (2000) Molecular mechanisms underlying differential odor responses of a mouse olfactory receptor, Proc. Natl Acad. Sci. U.S.A. 97, 10712-10716.
[5] Freddolino P L, et al. (2004). Structure and function prediction for human □2-adrenergic receptor. Proc. Natl. Acad. Sci. USA, 101, 2736-2741.
[6] Goddard W A and Abrol R (2007). 3D Structures of G-Protein Coupled Receptors and Binding Sites of Agonists and Antagonists. Journal of Nutrition 137, 1528S-1538S.
[7] Huang, Shoichet, and Irwin, (2006). Benchmarking sets for molecular docking. J. Med. Chem. 49, 6789-6801.
[8] Kalani M Y, et al. (2004). Three-dimensional structure of the human D2 dopamine receptor and the binding site and binding affinities for agonists and antagonists. Proc. Natl. Acad. Sci. USA, 101, 3815-3820.
[9] Kam V W T and Goddard W A (2008). Flat-Bottom Strategy for Improved Accuracy in Protein Side-Chain Placements. J. Chem. Theory Comput. 4, 2160-2169.
[10] Li Y Y, Zhu F Q, Vaidehi N, and Goddard W A (2007). Prediction of the 3D Structure and Dynamics of Human DP G-Protein Coupled Receptor Bound to an Agonist and an Antagonist. J. Am. Chem. Soc. 129, 10720-10731.
[11] Mayo, S. L., Olafson, B. D. Goddard III, W. A. (1990) DREIDING—a generic force field for molecular simulations. J. Phys. Chem. 94, 8897-8909.
[12] Moustakas D T, et al. (2006). Development and validation of a modular, extensible docking program: DOCK 5. J. Comput. Aided Mol. Design. 20, 601-609.
[13] Peng J Y P, et al. (2006). The Predicted 3D Structures of the Human M1 Muscarinic Acetylcholine Receptor with Agonist or Antagonist Bound. ChemMedChem 1, 878-890.
[14] Rocchia W, et al. (2001). Extending the applicability of the nonlinear Poisson-Boltzmann equation: Multiple dielectric constants and multivalent ions. J. Phys. Chem. B 105, 6507-6514.
[15] Vaidehi N, et al. (2002). Structure and Function of GPCRs. Proc. Natl. Acad. Sci., USA 99, 12622-12627.
[16] Vaidehi N, et al. (2006). Predictions of CCR1 chemokine receptor structure and BX 471 antagonist binding followed by experimental validation. J. Biol. Chem. 281, 27613-27620.
[17] Warren G L, et al. (2006). A critical assessment of docking programs and scoring functions. J. Med. Chem. 49, 5912-5931.

### APPENDIX 1

DarwinDock program options are given as follows:
Protein—Protein for a ligand to dock to. The protein is typically alanized (dehydrophobicated).
Ligand—Ligand conformation for the protein to dock with.
Spheres—A selection of spheres defining the binding region.
RMSD reference ligand—A ligand pose to compare generated poses to, such as the ligand from a crystal structure or previous docking run. A reference ligand pose is generally the pose observed in co-crystals and used to test the accuracy of a run. The reference ligand pose can also be from a previous docking run to test reproducibility of a method or parameters being tested.
Diversity—Clustering diversity for the DarwinDock program. The diversity determines tightness of the families.
Step Size—Size of the increment when generating new poses for clustering.
Completeness Threshold—Criteria for determining when complete sampling of the binding site has been obtained.
Percent of Families to Score—Percent of the families after completeness to apply energy scoring to.
Polar/Phobic/Total Poses—Number of poses from each of the three energy scoring types to be kept and passed to the next module. The next module can be used to narrow down on the set of ligand poses generated by DarwinDock. It can be one of the tools in, for instance, SCREAM, SCRWL, or GenDock.
Bump Cutoff—Bump cutoff passed to the UCSF Dock program during pose generation. The bump cutoff is the number of close contacts allowed between a ligand pose and the receiving protein. For instance, if the bump cutoff is two, a ligand pose that bumps into the receiving protein at three locations would not be considered a valid ligand pose and would be eliminated from consideration.

### APPENDIX 2

The clustering scheme that has been implemented as part of DarwinDock takes as an input a set of ligand poses, clusters them into families using a diversity value, and assigns a family head. The diversity value provides a threshold RMSD, wherein all members of a family are within the threshold RMSD. The diversity value determines tightness of a family, which in turn determines whether a particular member of the family can be the family head. A default value for the diversity value is 2 Å. However, this value can be changed (by a user) based on physical interactions between the ligand poses and the receiving protein.

The specific steps of the clustering step are as follows:
1. Calculate full RMSD matrix for all ligand conformations using heavy atoms (non-hydrogen).
2. Keep all RMSD matrix elements (r_{i,j}) less than or equal to the diversity value and sort the matrix elements in increasing order. Subscripts i and j refer to two different ligand poses.
3. Lowest matrix element r_{i,j} automatically places ligand poses i and j into the same family.
4. Starting with the next higher RMSD element r_{k,l}, one of three scenarios can arise:
   a. Pose k is part of an existing family and l is not part of an existing family. Thus, in order for pose l to become part of the family with pose k, pose l needs to have its RMSD value relative to all members of that family less than the diversity value. Since RMSD is defined between two poses, an RMSD of a relative to all members in a family needs to be smaller than or equal to the diversity value.
   b. Pose k is part of an existing family and l is part of another family. In order for the two families to merge and become one family, RMSD values across all poses in the two families need to be less than the diversity value.
   c. Pose k and pose 1 are not part of any families, and hence poses k and l start a new family.
   This is done until all RMSD elements are exhausted.
5. A family head is assigned to each family as one which is the geometric center of that family in the RMSD space. A family with two members has the family head as one with the lowest interaction energy with the target protein.

### APPENDIX 3

There are a number of helper programs which, while not directly called by DarwinDock, are used either in the preparation or analysis of DarwinDock runs. Some of these programs are briefly described here.

SphGen.pl

This program is a wrapper for the sphgen program in the UCSF DOCK package. The program performs the following:
1. Dehydrophobication—Bulky, nonpolar residues (V, L, I, F, Y, W, M) are alanized if desired.
2. Creates the molecular surface with DMS.
3. Generates spheres with sphgen.
4. Selects all “cluster 0” spheres.
5. Divides all spheres into 10 Å cubes (“boxes”) with 2 Å overlap, centered at the “center of mass” of the “cluster 0” spheres.
6. Optionally thin the spheres in each “box” to a specified diversity or number of spheres.

ThinSpheres.pl

This program takes as input a sphere file, such as one produced by SphGen.pl. It thins the spheres either to a specified diversity or number of spheres. The spheres are thinned by clustering the sphere set at a specified diversity, using the same clustering program used by DarwinDock. If there are more than two spheres in a given cluster, then the geometric family head is kept. If there are only two spheres in a cluster, then their coordinates are averaged to produce a single sphere. This process is performed twice at each clustering diversity.

MergeSpheres.pl

This program takes in multiple sphere regions, merges them, eliminates duplicate spheres if the regions overlap, and thins the resulting region to a specified number of spheres using the method in ThinSpheres.pl.

AlanizeAroundSpheres.pl

This program takes in a protein structure and a sphere region and alanizes/dehydrophobicates the residues within a specified distance of the sphere region. This is done primarily to reduce the number of residues that must be dealanized in the ScreamUnifiedBindSite module.

DefineLigandSite.pl

This program takes in a set of ligand poses and a sphere region (typically the full sphere set produced by sphgen) and selects all spheres within a given distance of any of the poses. This allows a user to focus a docking program on a specific binding site, such as one determined from a crystal structure or a previous docking run.

LigCluster.pl

This program takes in a large set of ligand conformations, minimizes each conformation, eliminates conformations exceeding an energy threshold, and then clusters the conformations twice using the algorithm described in Appendix 2. After the first clustering, the geometric family head is kept except for doublets (families with two members), where the best energy conformation is kept. The second clustering is performed on this new set at a different diversity, with the best energy conformation being kept from each family. This allows the user to take a large, diverse set of ligand conformations and winnow it down to a representative subset for docking.

1. A method for predicting binding poses of a binding molecule, wherein the binding molecule is adapted to be bound to a target molecule, the method comprising:
providing at least one molecular pose for the binding molecule;
clustering the at least one molecular pose into at least one family, wherein the clustering is based on position of each molecular conformation in the target molecule;
selecting a family head for each family in the at least one family based on geometric properties;
selecting a full set or subset of families based on interaction energy between each family head and the target molecule; and
selecting a full set or subset of molecular poses from among the molecular poses in the full set or subset of families based on interaction energy between each molecular pose and the target molecule.

2. The method of claim 1, further comprising, between the clustering and the family head selecting:
repeating the providing and the clustering until a ratio N/T is less than a threshold value, wherein N is a number of exclusively-new families formed in an iteration of the providing and the clustering and T is a total number of families formed up to and including the iteration, and wherein the threshold value is user-defined.

3. The method of claim 2, further comprising, before the providing:
scanning the target molecule to find at least one potential binding site,
wherein the providing, clustering, repeating, and molecular pose selecting is further based on the at least one potential binding site.

4. The method of claim 1, further comprising, before the providing:
scanning the target molecule to find at least one potential binding site,
wherein the providing, clustering, and molecular pose selecting is further based on the at least one potential binding site.

5. The method of claim 2, wherein, in each iteration of the providing and clustering, a constant number of additional molecular poses are generated and clustered.

6. The method of claim 1, wherein the interaction energy comprises at least one of total interaction energy, polar interaction energy, and phobic interaction energy.

7. The method of claim 1, wherein the interaction energy comprises total interaction energy, polar interaction energy, and phobic interaction energy and the molecular pose selecting comprises:
selecting a first set of molecular poses from among the molecular poses in the full set or subset of families based on the total interaction energy;
selecting a second set of molecular poses from among the molecular poses in the full set or subset of families based on the polar interaction energy; and
selecting a third set of molecular poses from among the molecular poses in the full set or subset of families based on the phobic interaction energy.

8. The method of claim 1, wherein the clustering comprises:
calculating a full root mean square difference (RMSD) matrix for each of the molecular poses in the at least one molecular pose;
selecting a subset of RMSD matrix elements based on a diversity value, wherein the diversity value is user defined; and
placing the at least one molecular conformations into a family in the at least one family based on values of the RMSD matrix elements.

9. The method of claim 8, wherein the selecting the subset of RMSD matrix elements comprises selecting RMSD matrix elements with values less than or equal to the diversity value.

10. The method of claim 1, wherein the binding molecule is selected from the group consisting of proteins, alanized proteins, lipids, peptides, and ligands.

11. A method for predicting ligand poses, wherein a ligand is adapted to be bonded with a receiving protein, comprising:
removing one or more residues on the receiving protein to form a mutant protein;
providing at least one ligand pose based on an input ligand pose and the mutant protein;
clustering the at least one ligand pose into at least one family, wherein the clustering is based on position of each ligand pose in the mutant protein;
selecting a family head for each family in the at least one family based on geometric properties;
selecting a full set or subset of families based on interaction energy between each family head and the mutant protein; and
selecting a full set or subset of ligand poses from among the ligand poses in the full set or subset of families based on interaction energy between each ligand pose and the mutant protein.

12. The method of claim 11, further comprising:
reintroducing the one or more residues on the mutant protein to reconstruct the receiving protein; and
selecting a final set of ligand poses from among the full set or subset of ligand poses based on interaction energy between each ligand pose and the receiving protein.

13. The method of claim 11, further comprising, before the removing:
scanning the receiving protein to find at least one potential binding site,
wherein the providing, clustering, and third selecting is further based on the at least one potential binding site.

14. The method of claim 11, further comprising, after the removing:
scanning the mutant protein to find at least one potential binding site,
wherein the providing, clustering, and third selecting is further based on the at least one potential binding site.

15. The method of claim 11, wherein the one or more residues in the removing are selected by a user.

16. The method of claim 11, wherein the one or more residues in the removing are selected based on polarity and size of each of the one or more residues.

17. The method of claim 11, wherein:
the removing comprises performing alanization on the receiving protein to obtain the mutant protein, and
the reintroduction comprises dealanization on the mutant protein to obtain the receiving protein.

18. The method of claim 11, wherein, in the removing, the one or more residues are selected from the group consisting of phenylalanine, isoleucine, leucine, methionine, tyrosine, valine, and tryptophan.

19. A computer readable medium comprising computer executable software code stored in said medium, which computer executable software code, upon execution, carries out the method of claim 1.

20. A computer readable medium comprising computer executable software code stored in said medium, which computer executable software code, upon execution, carries out the method of claim 11.
